(19) United States
(12) Patent Application Publication
(10) Pub. No.: US 2005/0056734 A1
(43) Pub. Date: Mar. 17, 2005

(54) Monitor tilting apparatus of AV system for motor vehicle

(75) Inventor: Sang-Ho Lee, Seoul (KR)

Correspondence Address: GREENBLUM & BERNSTEIN, P.L.C., 1950 ROLAND CLARKE PLACE, RESTON, VA, 20191, US

(73) Assignee: Hyundai Mobis. Co., Ltd., Yongin-shi (KR)

(21) Appl. No.: 10/704,573

(22) Filed: Nov. 12, 2003

(30) Foreign Application Priority Data
Sep. 15, 2003 (KR) 10-2003-0063534

(51) Int. Cl. G12B 9/10

(52) U.S. Cl. 248/27.3

(57) ABSTRACT

The present invention relates to a monitor tilting apparatus of an AV system for a motor vehicle, more particularly, to a tilting apparatus through which the monitor is not simply tilted at its place but moves straight forward before being tilted

The present disclosure relates to subject matter contained in priority Korean Application No. 10-2003-0063534, filed on Sep. 15, 2003, which is herein expressly incorporated by reference in its entirety.

### BACKGROUND OF THE INVENTION

1. Field of the Invention

The present invention relates to a monitor tilting apparatus of an AV system for a motor vehicle, more particularly, to a tilting apparatus through which the monitor is not simply tilted at its place but moves straight forward before being tilted.

2. Description of the Related Art

Korean Patent Publication No. 2000-33789 discloses a traditional tilting apparatus (refer to FIG. 1). According to the disclosure, when a motor 210 rotates, a driving force thereof is transferred to a rack 262 through reduction gears 240 and 250, and as a result, a tilting guide 260 moves a lower portion of the monitor 125 forward. Then, a hinge pin 272 formed on a top portion of the monitor 125 slides along a guide slot 274 of a guide rib 270, consequently tilting the monitor 125.

Since the traditional tilting apparatus requires a guiding member, such as the guide rib 270, for guiding the tilting motion of the upper portion of the monitor, an upper structure of a main body gets complicated to that extent. This not only creates an unshapely appearance for an AV system, but also restricts a space available for the monitor, as much space as the member.

Besides, the traditional tilting apparatus often gets interfered by a center fascia and other surrounding parts because the monitor is hardly separated from the main body and usually tilted at its place. To obviate the interference with the center fascia, manufacturers had to make smaller monitors.

### SUMMARY OF THE INVENTION

It is, therefore, an object of the present invention to provide a monitor tilting apparatus of an AV system for a motor vehicle, through which a monitor, before being tilted, moves straight forward by a predetermined distance from the AV system main body, whereby the monitor does not get in the way of the center fascia during a tilting motion.

Another object of the present invention is to provide a tilting apparatus with a very compact structure, by removing a complicated upper structure for guiding a tilting motion of a monitor.

Still another object of the present invention is to provide a tilting apparatus independent of size, having no complicated upper structure for guiding a tilting motion of a monitor or possibility of getting interfered by surrounding parts during a tilting motion.

To achieve the above object, there is provided a monitor tilting apparatus of an AV system for a motor vehicle, the apparatus including: a frame fastened onto a vehicle body, the frame including a slot part with a fixed slot; a back-and-forth motion member having a moving slot, moving a lower portion of the monitor back and forth by means of a hinge connected to the lower portion of the monitor of the AV system for the motor vehicle; and a link member, one end being hinged to the monitor and the other end being hinged to the fixed slot on the frame and the moving slot on the back-and-forth motion member, respectively, wherein the fixed slot formed on the frame is bent downward at an end of the monitor side, and the moving slot formed on the back-and-forth member is bent upward at an end of the monitor side.

### BRIEF DESCRIPTION OF THE DRAWINGS

The above objects, features and advantages of the present invention will become more apparent from the following detailed description when taken in conjunction with the accompanying drawings, in which:

FIG. 1 illustrates a related art monitor tilting apparatus;

FIG. 2 illustrates a monitor tilting apparatus of an AV system for a motor vehicle according to a preferred embodiment of the present invention;

FIG. 3 depicts a state prior to an operation of a monitor tilting apparatus of the present invention;

FIG. 4 depicts a state after a monitor makes a straight-line (or linear) motion to a front with the help of a monitor tilting apparatus of the present invention;

FIG. 5 depicts a state in which a monitor starts being tilted with the help of a monitor tilting apparatus of the present invention;

FIG. 6 depicts a state in which a monitor is completed tilted with the help of a monitor tilting apparatus of the present invention; and

FIG. 7 illustrates an embodiment of a transfer means of a back-and-forth motion member included in the present invention.

### DETAILED DESCRIPTION OF THE PREFERRED EMBODIMENT

A preferred embodiment of the present invention will now be described with reference to the accompanying drawings.

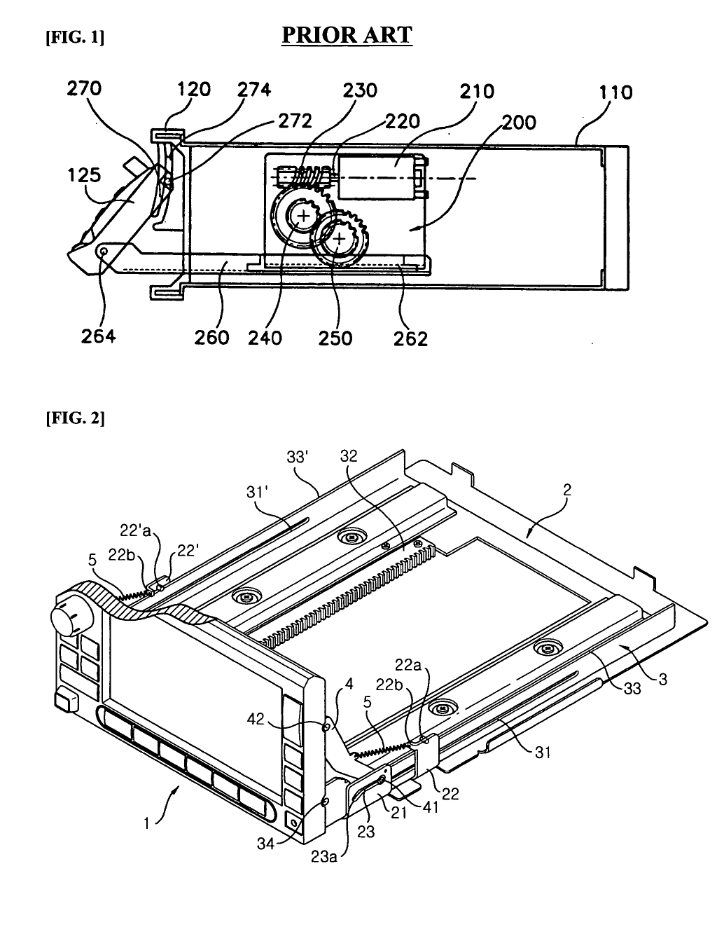

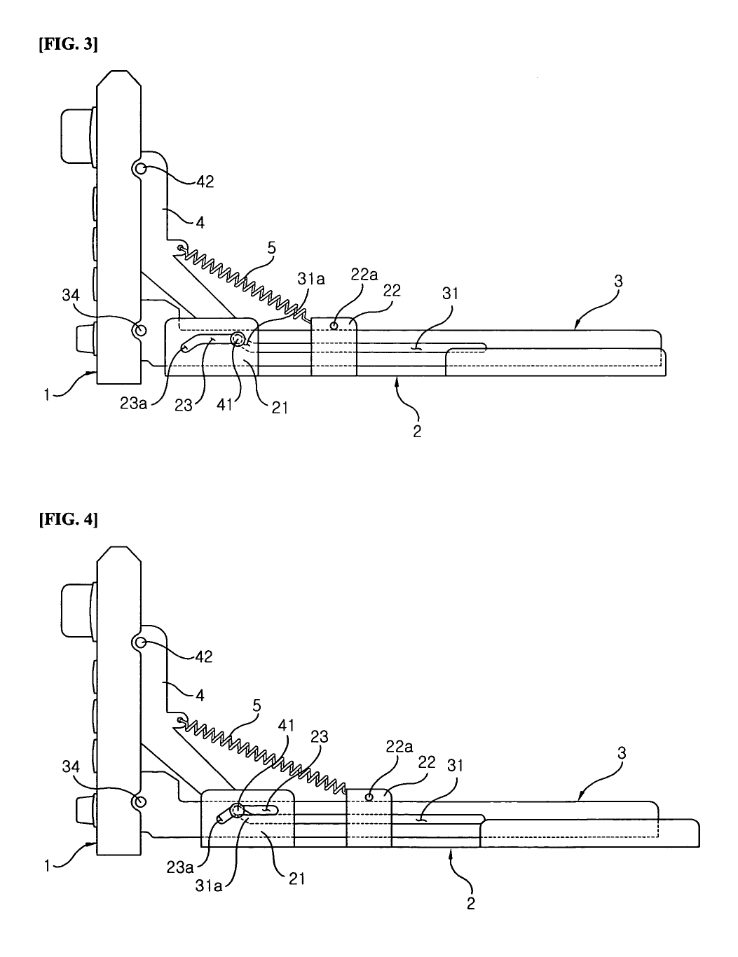

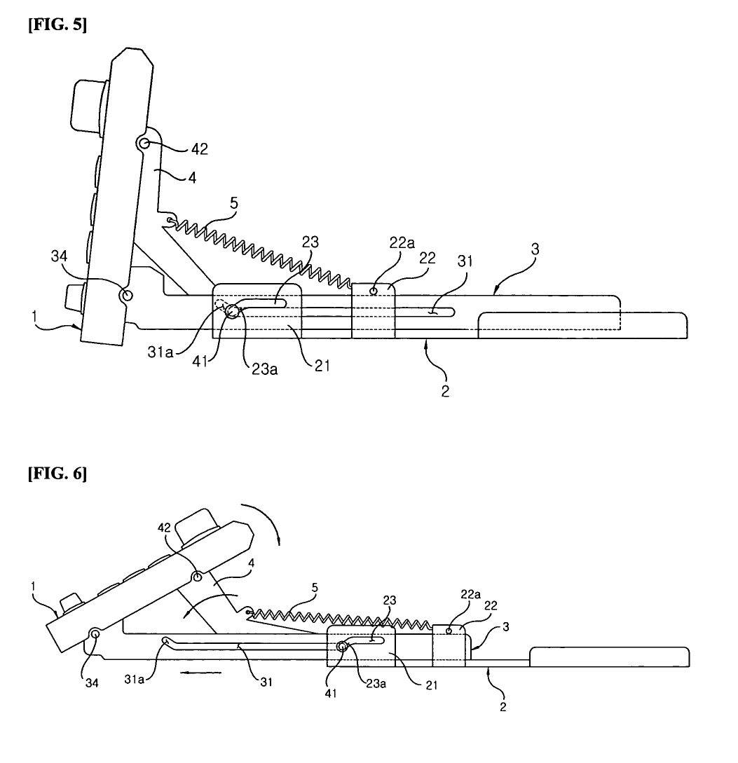

FIG. 2 illustrates a tilting apparatus connected to a monitor 1. FIGS. 3 through 6 illustrate a step-by-step procedure showing how the monitor 1 is tilted by the tilting apparatus. As depicted in the drawings, the motion of the monitor 1 is largely divided into two parts: a linear motion section (FIGS. 3 and 4) and a tilt motion section (FIGS. 4 through 6).

Referring to the drawings, a frame 2 being fixed onto a vehicle body, preferably to a main body lower frame of an AV system, includes a slot part 21, and a slot (hereinafter it is referred to as a ‘fixed slot’) on the slot part 21. At the end of the monitor side of the fixed slot 23 is a downward bending part 23a that is bent downward.

The back-and-forth motion member 3 is connected to a lower portion of the monitor 1 through a hinge 34, so its role is to move the lower portion of the monitor 1 back and forth. As depicted in the drawings, a slot (hereinafter it is referred to as a ‘moving slot’) is formed on a body of the back-and-forth motion member 3. At the end of the monitor side of the moving slot 23 is an upward bending part 23a that is bent upward. Preferably, a rack 32 is formed on the back-and-forth motion member 3, and more details on this will be provided later.

An end of a link member 4 is connected to the monitor 1 through a hinge 42, and the other end of the link member 4 is connected to the fixed slot 23 and the moving slot 31 through a hinge 41. Particularly, the link member 4 is connected to an upper part of the monitor 1, rather than a center thereof, so that the monitor 1 can more easily move straight forward within its straight-line motion section. Also, the central portion of the link member 4 is bent in such a manner that the upper portion of the link member is adjacent to the monitor in parallel. In this way, the upper portion of the link member 4 does not get in the way of other parts, and the monitor 1 can freely make its linear motion in the straight-line motion section.

On the other hand, a straight-line rail 33 is formed on the back-and-forth motion member 3, and in the frame 2, there is a support part 22 being in contact with the rail 33, having a support pin 22a for supporting the back-and-forth motion member 3 downward. The support part 22 is preferably formed in the rear of the slot part 21. With this simple structure using the rail 33 and the support part 22 of the frame 2, the back-and-forth motion member 3 can freely make its linear motion. More preferably, the support pin includes a resin roller.

Also, as shown in FIG. 2, the frame 2 and the link member 4 are connected to each other by a spring 5 therebetween. In so doing, a backlash problem during the tilting motion of the monitor 1 can be solved, and the monitor 1 would not be shaky during its motion because of dimension tolerance or loose associated connection parts, e.g. hinges.

Referring now FIGS. 3 through 6, an operational procedure of the tilting apparatus with the above structure will be explained.

To begin with, FIG. 3 depicts a state where the monitor 1 is not yet tilted. As shown in the drawing, the hinge shaft 41 at one end of the link member 4 is inserted into an upward bending part 31a in the front of the moving slot 31 and a rear end of the fixed slot 23.

In this state, when the back-and-forth motion member 3 moves forward, the upward bending part 31a of the back-and-forth motion member 3 shifts the hinge shaft 41 of the link member 4 to the front part inside the fixed slot 23. Then the monitor 1 connected to the link member 4 and the back-and-forth motion member 3, while maintaining its upright posture, moves straight forward. The straight-line motion of the monitor 1 comes to an end when the hinge shaft 41 reaches a downward bending part 23a of the fixed slot 23, as illustrated in FIG. 4.

In the state shown in FIG. 4, if the back-and-forth motion member 3 keeps moving forward, the hinge shaft 41 moves along the downward bending part 23a of the fixed slot 23 through the upward bending part 31a of the moving slot 31, and eventually stops in the state depicted in FIG. 5.

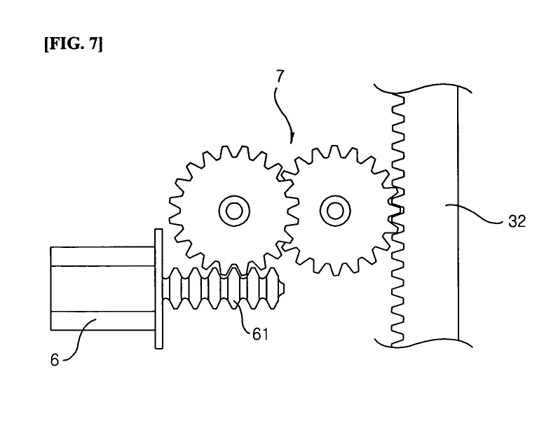

Referring to FIG. 5, the hinge shaft 41 stops moving by the downward bending part 23a of the fixed slot 23, and the back-and-forth motion member 3 continues moving to the front. As the back-and-forth motion member 3 continues moving forward, the lower portion of the monitor 1 also moves forward, and the link member 4 is rotated downward, with respect to the hinge shaft 41. That is, the monitor 1 is tilted when the lower portion of the monitor 1 keeps moving forward, and the link member 4 is rotated downward. As FIG. 6 depicts, the tilt motion of the monitor 1 is completed as soon as the end of the moving slot 31 is caught by the hinge shaft 41.

Since a procedure of returning the tilted monitor 1 back to its normal position is just opposite of the tilting procedure that has been discussed above, it will be unnecessary to provide more details thereon.

In the meantime, to help the back-and-forth motion of the back-and-forth motion member 3, there is a rack 32 formed on the back-and-forth motion member 3, as illustrated in FIG. 7, in which the rack is connected to a designated motor 6 through a reduction gear 7.

While the invention has been shown and described with reference to certain preferred embodiments thereof, it will be understood by those skilled in the art that various changes in form and details may be made therein without departing from the spirit and scope of the invention as defined by the appended claims.

In short, the monitor tilting apparatus of the present invention has the following advantages.

First, unlike the monitor tilting apparatus of the related art, the monitor tilting apparatus of the invention first moves the monitor forward while allowing the monitor to maintain its upright position, and then tilts the monitor.

Second, because the monitor is tilted after it makes a linear motion, it is not interfered by the center fascia or other surrounding parts.

Third, there is no need to use the upper structure of the related art for guiding the tilting motion of the monitor, so the AV system can have a compact structure.

Fourth, there is no restriction on the size of the monitor since the monitor does not get in the way of the upper structure or other parts anyway.

Fifth, the monitor can more freely move with the help of the spring because the backlash problem no longer exists.

1. A monitor tilting apparatus of an AV system for a motor vehicle, the apparatus comprising:
a frame fastened onto a vehicle body, including a slot part with a fixed slot;
a back-and-forth motion member having a moving slot, moving a lower portion of the monitor back and forth by means of a hinge connected to the lower portion of the monitor of the AV system for the motor vehicle; and
a link member, one end being hinged to the monitor and the other end being hinged to the fixed slot on the frame and the moving slot on the back-and-forth motion member, respectively, wherein the fixed slot formed on the frame is bent downward at an end of the monitor side, and the moving slot formed on the back-and-forth member is bent upward at an end of the monitor side.

2. The monitor tilting apparatus according to claim 1, further comprising:
a spring for interconnecting the link member with the frame.

3. The monitor tilting apparatus according to claim 1, wherein a straight-line rail is formed on the back-and-forth motion member, and the frame is positioned in a rear of the slot part, the frame comprising a support part for supporting the back-and-forth motion member downward by being in contact with the rail on the back-and-forth motion member.

4. The monitor tilting apparatus according to claim 2, wherein a straight-line rail is formed on the back-and-forth motion member, and the frame is positioned in a rear of the slot part, the frame comprising a support part for supporting the back-and-forth motion member downward by being in contact with the rail on the back-and-forth motion member.
